(19) United States
(12) Patent Application Publication
(10) Pub. No.: US 2003/0213176 A1
(43) Pub. Date: Nov. 20, 2003

(54) Method and apparatus for the temporary support of synthetic natural gas in residential and small commercial applications

(76) Inventor: Wolfgang H. Driftmeier, Lawrenceville, GA (US)

Correspondence Address: Wolfgang H. Driftmeier, 210 Prospect Park, Peachtree City, GA, 30269, US

(21) Appl. No.: 10/144,207

(22) Filed: May 14, 2002

(51) Int. Cl. C01B 3/24

(52) U.S. Cl. 48/127.3; 48/127.9; 48/180.1; 48/189.3

(57) ABSTRACT

A small apparatus for the production of mixtures of LPG vapor and air, also called synthetic natural gas, with properties that allow these mixtures to be used in place of natural gas in mostly temporary installations for residential and industrial or commercial installations. The entire apparatus is designed to produce synthetic natural gas without permanent presence of operating personnel. Noise, typically associated with the operation of venturi-type vapor/air mixing devices, is suppressed by a combination of an air-intake filter and a noise-reducing device to a level that make the apparatus suitable for installations close to residential developments. A second vapor/air mixing apparatus, identical to the main system, is installed on the same support frame, acting as a backup device for the main system in situations of equipment malfunctions or temporary system overload. Equipment malfunctions are reported to centralized monitoring stations by means of a telephone-based signaling device. Backup operating energy is provided by means of a solar-powered current converter with battery backup.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to an apparatus and method that provide the benefits of natural gas, such as low cost to the consumer and low emissions to protect the environment, for temporary installations (approximately two to seven years) without the restrictions of standard propane-air systems, which typically require expensive equipment, permanent staffing, considerable space for the installation of the equipment, and costly maintenance procedures, by employing the method of taking LPG vapor directly from the storage tank, routing it through a pressure stabilizer into a naturally aspirated LPG Vapor/Air Mixing device, and producing a gas with properties that make the gas compatible and directly interchangeable with natural gas.

Traditionally, new residential or commercial developments that do not have direct access to the existing natural gas pipeline infrastructure, but require or desire gas as an energy source for heating purposes or for the processing of goods, are connected to a source of LPG vapor (Liquefied Petroleum Gas), such as propane, butane, or mixtures of propane and butane. All connected equipment, such as household appliances and processing machines, must be configured to accept LPG gas.

Once the gas utility company that serves the area in which the new development is located is able to extend the natural gas pipeline infrastructure to the new development, all connected equipment, such as household appliances and processing machines, must be reconfigured to accept natural gas.

With very few exceptions, re-configuring the connected equipment, such as household appliances and processing machines, requires replacing control components, such as pressure regulators, control valves, burners, burner pilots, etc. Depending on how long after the initial installation this re-configuration occurs, the components necessary for the new configuration may have become obsolete, requiring complete replacement of the installed equipment. There is also a considerable amount of labor involved with this reconfiguration.

The art of manufacturing synthetic natural gas (SNG) from a mixture of LPG gas and air has long been established. However, equipment necessary for the manufacturing of SNG typically involves liquid transfer pumps, LPG vaporizers, separate LPG/air mixing equipment, system control and monitoring equipment, and skilled operating personnel. The employed equipment is generally large in size, expensive, and requires real estate of considerable proportions for the installation of the equipment. Because of these reasons, typical SNG manufacturing plants are normally considered desirable only for medium to large size installations, such as entire towns or large industrial users.

It has long been the desire of utility companies to have de-centralized SNG plants that are capable of producing SNG of high quality, without the need for permanent operating personnel, and sized to supply SNG to as few as 10 to 20 homes in a subdivision, or one or two commercial users in an industrial park.

Employing de-centralized SNG plants would allow the connected equipment, such as household appliances and processing machines, to be initially configured for natural gas use, without the need to re-configure the equipment once the newly developed area is being connected to an expanded natural gas pipeline grid.

### BRIEF SUMMARY OF THE INVENTION

The invention relates to an apparatus and a method that provide the benefits of natural gas, such as low cost to the consumer and low emissions to protect the environment, for temporary installations (approximately two to seven years) without the aforementioned restrictions of standard propane-air systems.

The invention does not require expensive equipment or permanent staffing, can be installed in very little space, does not require costly maintenance procedures, and allows connected consumers to be moved to natural gas supply without the need of re-configuring their gas-using equipment.

The invention employs the method of taking LPG vapor directly from a storage tank, routing it through a pressure stabilizer into a naturally aspirated LPG Vapor/Air Mixing device, producing synthetic natural gas with properties that make it compatible and directly interchangeable with natural gas. Equipment, such as household appliances and processing equipment, function and perform on synthetic natural gas the same way they perform when they are connected to natural gas.

Accordingly, it is an object of the present invention to provide a method and apparatus for producing synthetic natural gas with properties that make it compatible and directly interchangeable with natural gas.

Another object of the present invention is to be of such design that liquid transfer pumps are not required.

Another object of the present invention is to be of such design that permanent operating personnel are not required.

Another object of the present invention is to be of small design, so that it can be installed in residential neighborhoods and small industrial parks without the need for large amounts of real estate.

Another object of the present invention is to be of such design that the level of noise emitted during the operation of the SNG plant is negligible.

Another object of the present invention is to be of such design that consumers that are initially connected to the SNG plant can later be switched to natural gas supply without the need for modifications to their appliances and processing equipment.

Other objects and advantages, besides those discussed above, will be apparent to those of ordinary skill in the art from the detailed description of the invention which follows. In the description, reference is made to the accompanying drawing, which forms a part hereof, and which illustrates examples of the invention. Such examples, however, are not exhaustive of the various embodiments of the invention and, therefore, reference is made to the claims which follow the description for determining the scope of the invention.

### BRIEF DESCRIPTION OF THE SEVERAL VIEWS OF THE DRAWING

FIG. 1 is an isometric diagram of an apparatus for practicing the method of the present invention.

### DETAILED DESCRIPTION OF THE INVENTION

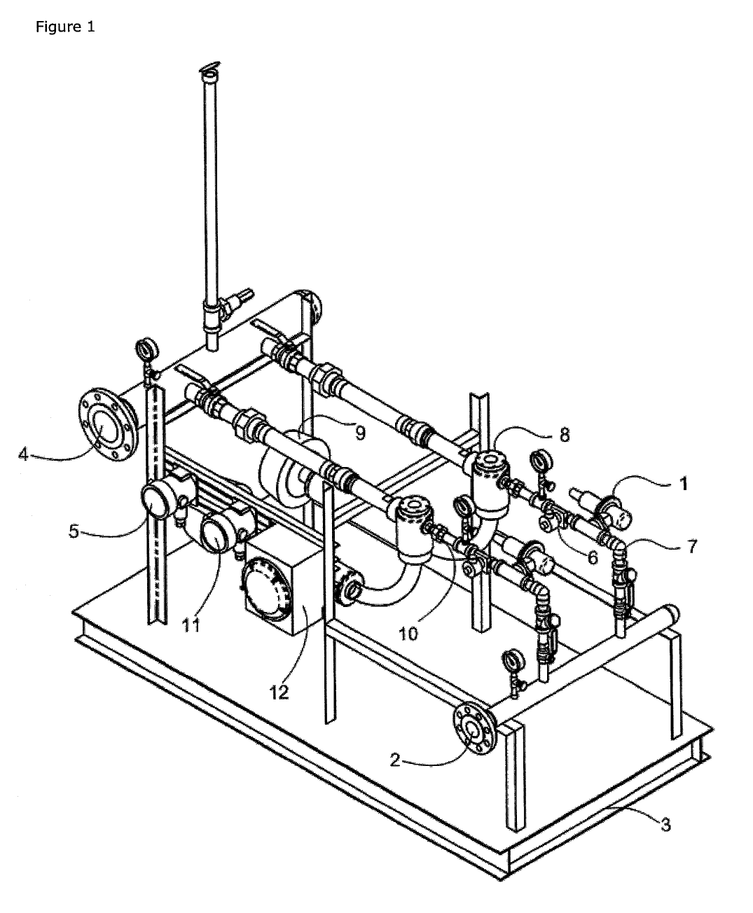

Referring to FIG. 1, a first embodiment of an apparatus for practicing the method of the invention uses a first level pressure regulator (1) to supply LPG vapor that is taken from the vapor space of a storage tank to the vapor inlet (2) of the mixer skid (3).

The pressure at the SNG outlet (4) is constantly monitored by a pressure sensing device (5). As SNG is consumed by connected appliances and other equipment, the pressure at the SNG outlet (4) falls. When the pressure falls below a certain setpoint, the pressure sensing device (5) closes an electrical contact, which energizes a solenoid valve (6) in the vapor supply line (7).

LPG vapor from the vapor inlet (2) flows through the vapor/air mixing assembly (8). The motive force of this venturi arrangement draws ambient air through a silencer (9) into the vapor stream at a ratio that is determined by (a) the vapor pressure and (b) the mechanical dimensions of the venturi arrangement. The vapor/air mixture then enters the connected pipeline grid through the SNG outlet (4).

When the pressure at the SNG outlet (4) is again above the pressure setpoint, the electric contact in the pressure sensing device (5) opens and de-energizes the solenoid valve (6), stopping the vapor flow and, thereby, the vapor/air mixing action.

This process repeats itself each time the pressure in the pipeline grid changes.

Electrical energy for the operation of the solenoid valve (6) is supplied by regular 110 V AC power with optional solar-powered battery backup. This arrangement allows for extended periods of operation at times of interrupted electrical supply.

A second, identical mixer assembly (10) on the same skid (3) is automatically activated by a second pressure sensing device (11) if the pipeline pressure cannot be maintained by the first mixer assembly due to malfunction or temporary system overload.

Each time the second mixer assembly (10) is activated, which is indicative of an equipment malfunction or of a system overload situation, a signaling device (12) notifies the remote system monitoring equipment of the utility company of this event.

I claim:

1. A method for providing the benefits of natural gas for temporary gas supply installations for residential or commercial users who are not yet connected to the main natural gas pipeline grid, the method comprising:
using a source of LPG vapor and mixing this vapor with air at a pre-determined ratio, creating a vapor/air mixture with gas properties similar to those of natural gas, making the manufactured gas compatible and interchangeable with natural gas;
creating a gas that burns with environmentally acceptable, low emissions;
allowing the use of readily available appliances and other natural gas burning equipment without the need for later re-configuration when these devices are connected to the main natural gas pipeline grid;
operating the gas-producing equipment without the need for continuous supervision or permanent staffing;
operating the gas-producing equipment from a site close to the gas users, typically inside a residential or commercial development;
operating the gas-producing equipment from small real estate lots without the need for large installation clearings.

2. The method of claim 1, wherein the size (design capacity) of the gas-producing equipment can be adapted to the specific needs of the installation location and the number and size of the connected users.

3. The method of claim 1, wherein centralized system monitoring stations will automatically be notified of equipment malfunctions or overload situations.

4. An apparatus for producing a mixture of LPG vapor and air at a pre-determined ratio, creating a vapor/air mixture with gas properties similar to those of natural gas, making the manufactured gas compatible and interchangeable with natural gas comprising:
an installation platform that is ready for placement on a user-prepared surface;
a properly sized vapor connection;
a properly sized gas outlet connection;
one or more first-level vapor pressure regulators;
one or more naturally aspirated vapor/air mixing devices that operate on the venturi principle;
one or more air inlet filters with noise-reduction devices;
one or more pressure sensing devices for the on/off control of the mixing apparatus;
one or more magnetically actuated flow control valves;
an electronic device for the automatic notification of centralized monitoring stations of system malfunctions or system overload situations.

5. The apparatus of claim 4, wherein the air-intake components of the vapor/air mixing lines are connected to a noise-reducing device, making the apparatus suitable for installation in residential areas.

6. The apparatus of claim 4, wherein each vapor/air mixing line can be equipped with independently acting first-level pressure regulators, allowing for individual adjustment of the properties of the gas produced by each mixing line.

7. The apparatus of claim 4, wherein the sendout pressure of the produced gas from each mixing line can be changed through adjustments of the settings of the first-level pressure regulator in each line.

8. The apparatus of claim 4, wherein the electric control components are supplied by standard line power with a solar-powered battery backup.

9. The apparatus of claim 4, wherein the equipment for the notification of a centralized monitoring station can communicate via telephone connection.

10. The apparatus of claim 9, wherein the telephone connection can be based on land line communication, or on radio frequency transmission (cell phone connection).

11. The apparatus of claim 1, wherein all components are given a surface finish treatment for prolonged service in an unprotected environment.

12. The apparatus of claim 11, wherein the surface finish of all components can be selected to allow integration into the existing environment.

13. The apparatus of claim 4, wherein the produced gas has properties that allow the continued use of high-efficiency, low-emission appliances and other gas-burning equipment.
